(19) United States
(12) Patent Application Publication
(10) Pub. No.: US 2006/0019046 A1
(43) Pub. Date: Jan. 26, 2006

(54) Convex/concave objects formed from co-polymer materials

(76) Inventor: Charlie D. Deane, Seattle, WA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/899,228

(22) Filed: Jul. 23, 2004

(51) Int. Cl. B29D 22/00; B32B 1/00

(52) U.S. Cl. 428/35.7; 428/174; 264/570; 264/571; 264/322

(57) ABSTRACT

A decorative layer selected from the group of materials comprising textile fabrics, dry plant leaves, dry grasses, dry flowers, rocks, gems, glitter, crushed glass, metals, meshes, wire, wood veneers, twigs, shells, glass beads, ceramic beads, poly beads, papers, vinyls and combinations thereof, is sandwiched between a co-polymer first layer and a co-polymer second layer. The sandwich structure is heated and then placed in alignment with a mold having a forming surface. The sandwich of materials and the mold are moved relatively together, causing the sandwich of materials to contact the forming surface of the mold and take on its shape. A vacuum may be used for pulling the sandwich of sheet materials towards the forming surface of the mold. In place of the vacuum, or in addition to it, positive pressure may be used to push the sandwich of materials against the forming surface. The first and second layers are selected from a group of materials comprising polymethylmethacrylate, polycarbonate, polyvinyl chloride, and polyethylene terephthalate glycol (PETG). One or both of the exposed surfaces of the object that is created may be textured.

### TECHNICAL FIELD

This invention relates to convex/concave objects made from at least two-layers of co-polymer materials and a decorative third layer that is sandwiched between them. More particularly, it relates to convex/concave vessels of different shapes, sizes and thickness to be used as sinks, bowls, lamp shades, furniture items, vases, etc. and to a method of manufacturing the convex/concave objects.

### BACKGROUND OF THE INVENTION

It is known to make articles of furnitures and other decorative articles by laminating layers of co-polymer and other materials. See for example U.S. Pat. No. 4,293,603, granted Oct. 6, 1981 to Charles R. Hayman-Chaffey and Fredrick W. Hayman-Chaffey; U.S. Pat. No. 5,403,631, granted Apr. 4, 1995 to Yusake Sato and Ryozo Amano, and U.S. Pat. No. 5,643,666, granted Jul. 1, 1997 to Michael Dennis Eckert and Raymond Lynn Goodson. There is a need to extend the creativity evidenced by these patents by using more and different materials and using them for making additional decorative articles. An object of this invention is to provide a new basin structure and a new method of manufacturing such basin structure. The basin structure of the present invention utilizes by layers of co-polymer materials and decorative layers selected from a large variety of materials.

### BRIEF SUMMARY OF THE INVENTION

A convex/concave object of the present invention is basically characterized by a co-polymer first layer; a co-polymer second layer; and a decorative third layer sandwiched between the first and second layers. The first, second, and third layers are bonded together to form an integrated structure.

In preferred form, the first and second layers are each selected from the group of materials comprising polymethylmethacrylate, polycarbonate, polyvinyl chloride and polyethylene terephthalate glycol (PETG). The decorative third layer is selected from the group of materials comprising textile fabrics, dry plant leafs, dry grasses, dry flowers, rocks, gems, glitter, crushed glass, metals, meshes, wire, wood veneers, twigs, shells, glass beads, ceramic beads, poly beads, papers, vinyls and combinations thereof.

The method of the present invention is basically characterized by providing a mold having a forming surface, e.g., a convex surface and a sandwich of sheet materials comprising a co-polymer first layer, a co-polymer second layer and a decorative third layer between the first and second layer. This sandwich of sheet materials is heated to a plastic state. Then, the heated sandwich of sheet materials and the forming surface are moved relatively together, to cause the forming surface to contact the heated sandwich of sheet materials. Positive pressure and/or a vacuum are used for moving the heated sandwich of sheet materials tight against the forming surface of the mold, causing the sheet materials to bond together and conform to the shape of the forming surface of the mold. After shaping, the bonded sheet materials are separated from the male mold and their edges are trimmed to provide a convex/concave object with a trimmed edge.

Other object, advantages and features of the invention will become apparent from the description of the best mode set forth below, from the drawings, from the claims and from the principles that are embodied in the specific structures that are illustrated and described.

### BRIEF DESCRIPTION OF THE SEVERAL VIEWS OF THE DRAWING

Like reference numerals are used to designate like parts throughout the several views of the drawing, and:

FIG. 1 is a pictorial view taken from above and looking towards the top, the front and one side of a sink basin of the present invention and its support structure and a faucet;

FIG. 2 is a side elevational view of the basin assembly shown by FIG. 1, looking towards the side of the assembly that is in the rear in FIG. 1;

FIG. 3 is a sectional view through the basin of FIGS. 1 and 2, taken substantially along line 3-3 of FIG. 1;

FIG. 4 is a view like FIG. 3, but of a tilted basin;

FIG. 5 is a pictorial flow diagram of the forming apparatus and steps used in the manufacture of the basin;

FIG. 6 is a sectional view of a third embodiment of the basin, taken substantially along line 6-6 of FIG. 7;

FIG. 7 is a top plan view of the basin shown by FIG. 6;

FIG. 8 is a pictorial view of a mounting frame for the materials used for forming the basin;

FIG. 8A is a pictorial view of the bottom layer shown in FIG. 8;

FIG. 9 is an exploded elevational view, with some parts in section, of forming equipment used in a first process embodiment of the invention;

FIG. 10 is a sectional view taken through a wall portion of an embodiment of the invention;

FIG. 11 is a view like FIG. 9, showing forming equipment used in a second process of the embodiment of the invention;

FIG. 12 is an elevational view of a clamp that is used to connect an upper frame structure to an upper housing, such a view showing the clamp in an open position;

FIG. 13 is a fragmentary sectional view showing the claim of FIG. 12 used to connect the upper housing to the upper frame, and showing the upper housing bearing down on the upper frame, such a view further showing the upper frame bearing down on the basin of the invention;

FIG. 14 is a sectional view taken through a portion of the upper frame, showing a lower portion of the upper housing and a guide member that is attached to the lower portion of the upper housing;

FIG. 15 is a sectional view taken substantially along line 15-15 of FIG. 16; and

FIG. 16 is top plan view, looking down towards the top of FIG. 15.

### DETAILED DESCRIPTION OF THE INVENTION

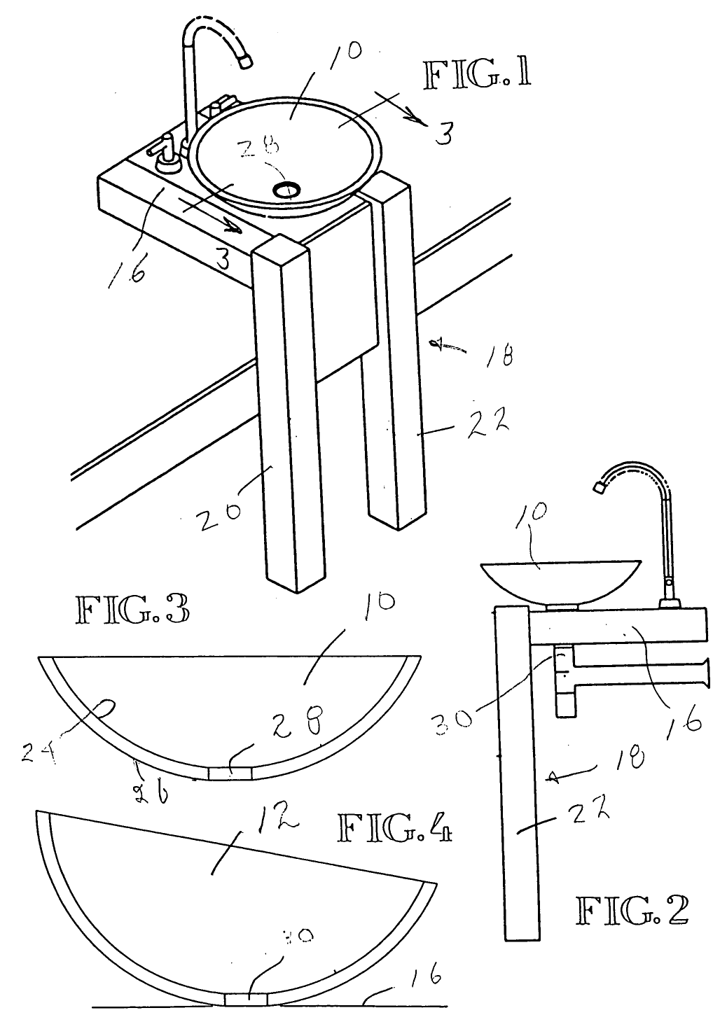

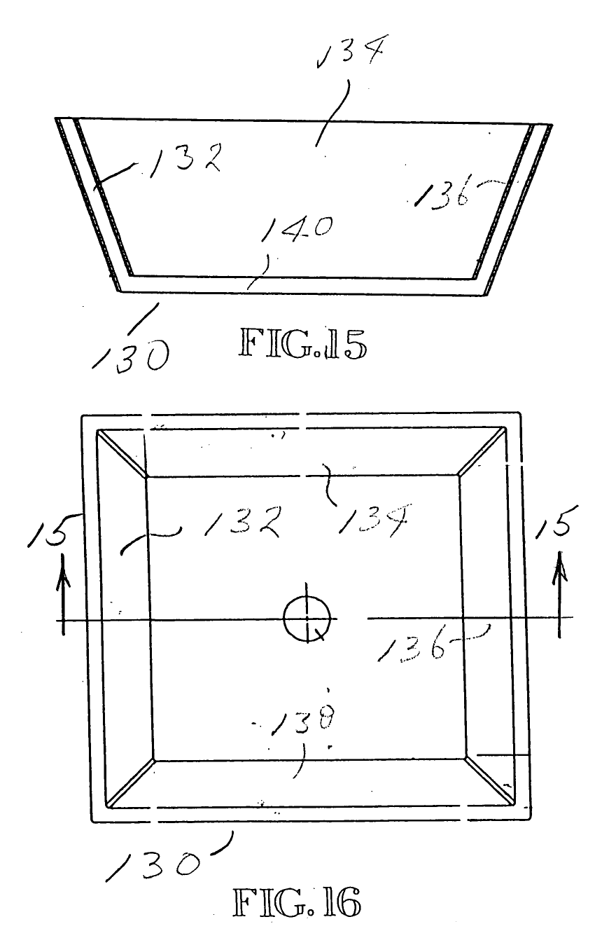

FIGS. 1-4, 6, 7, 15 and 16 show four different sink basins that are constructed in accordance with the present invention. In FIGS. 1 and 2, a basin 10 is supported on and by a base having a horizontal portion 16 and a vertical portion 18 including a pair of legs 20, 22. The basin 10 has a concave upper surface 24 and a convex lower surface 26. At its center, it includes a drain opening 28 shown in FIG. 2 to be connected to a drainpipe 30. In the embodiment of FIG. 4, the basin 12 is titled and the drain opening 30 is provided where the base of the basin 12 contacts the member 16. The embodiment of FIGS. 6 and 7 includes a basin 14 having a rim 30 which is formed from the same materials as the basin 14. The embodiment of FIGS. 15 and 16 is a four-sided convex/concave basin.

FIG. 5 shows a lower housing 34 on which a male form member 36 is mounted. A sandwich structure 38 of layers is positionable above the male form member 36. An upper housing 40 may be positioned above the sandwich structure 38. FIG. 8 shows the sandwich structure 38 positioned above a frame 42 having inner frame members 44, 46, 48, 50 which are fixed in position on the frame 42. Conventional clamps C are movable towards and away from frame members 44, 46, 48, 50 such as by use of fluid motors 52. Suitable clamps are obtainable from Brown Machine having a business address at 330 North Frost Street, Post Office Box 434, Beaverton, Mich. 43612. The sandwich structure 38 is placed on the frame 42 and the clamp cylinders 52 are operated to move the clamps C and clamp the edges of the sandwich 38 to the frame member 44, 46, 48, 50.

The sandwich structure 38 comprises but is not limited to an upper layer 54, a lower layer 56, and an intermediate layer 58. As shown by FIG. 8, the lower layer 56 may include air escape openings 60. In preferred form, the layers 54, 56 are made from a co-polymer material. The intermediate layer 58 is a layer of decorative material. The upper and lower layers 54, 56 are made from materials that are selected from the group of materials comprising polymethylmethacrylate, polycarbonate, polyvinyl chloride and polyethylene terephthalate glycol (PETG). By way of typical and therefore non-limitive example, one of the first and second layers may be a sheet of continuously cast cross-link polymethylmethacrylate. The other may be constructed from extruded polymethylmethacrylate. The decorative third layer is selected from a group of materials comprising textile fabrics, dry plant leafs, dry grasses, dry flowers, rocks, gems, glitter, crushed glass, metals, meshes, wire, wood veneers, twigs, shells, glass beads, ceramic beads, poly beads, papers, vinyls and combinations thereof.

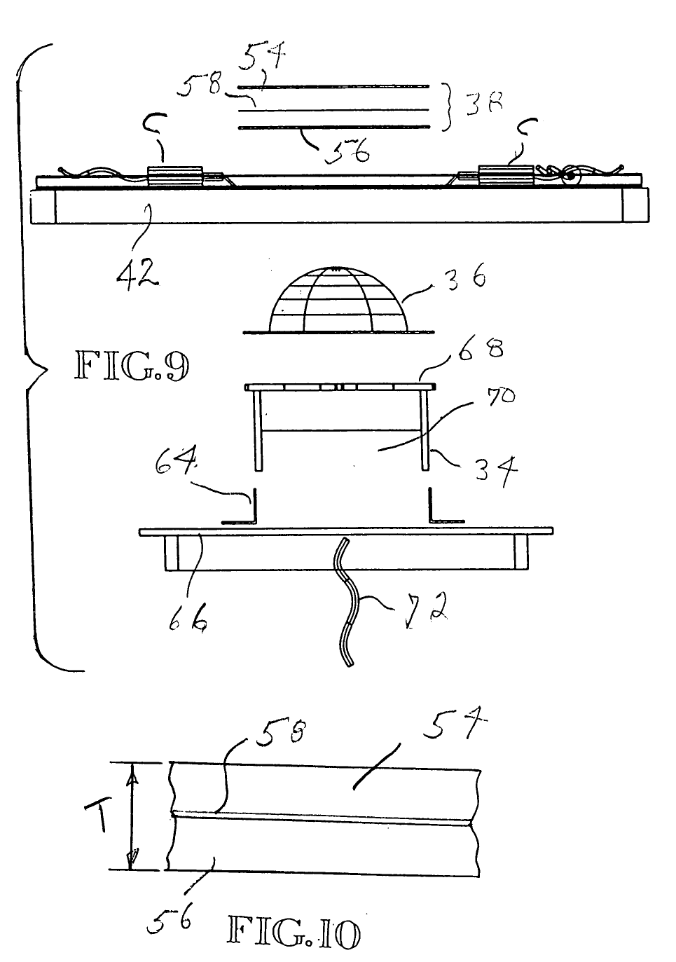

Referring to FIG. 9, the male mold 36 is mountable on the top 68 of the housing 34. The top 68 includes openings (not shown) which communicate the space below top 68 with the space above top 68. Lower housing 34 is connected by an angle member 64 to base 66. When members 64 are connected to base 66, the housing structure 34 is connected to the angle members 64 and the male mold 36 is connected to the top 68, a space 70 is defined inside of the structure 34, 64, above the base 66 and below the top 68. This space 70 is connected to a source of vacuum by a vacuum hose 72.

After the sandwich structure 38 is connected to the frame 42 by the clamps C, the frame 42 is placed in an oven and the temperature is controlled to between 200 to 450 degrees Fahrenheit. When the sandwich structure 38 is hot enough to be soft and plastic, it is removed from the oven and positioned above the male mold 36. Specifically, the frame 42 is moved into a position which places the sandwich structure 38 above the male mold 36. Then the frame 42 is anchored so that the sandwich structure 38 is also anchored. Then the male mold 36 is moved upwardly so that its convex upper surface is pressed against the bottom of the sandwich structure 38. At the same time, a vacuum is pulled into chamber 70, causing the sandwich structure to move against and take on the shape of the upper forming surface of the male mold 36. Openings in the member 68 and the mold 36, and the openings 60 in the lower layer 56 of the sandwich structure 38, allow sufficient air movement that the sandwich structure 38 can and will be moved against the forming surface of the mold 36. The openings 60 (FIG. 8A) allow air inside the sandwich 38 to escape during the forming process. After the sandwich structure 38 is formed, it is moved away from the male mold 36 and its upper part 39 is cut away from its lower part 41. The cut edge of the upper part is suitably dressed and the lower part which is excess material is discarded.

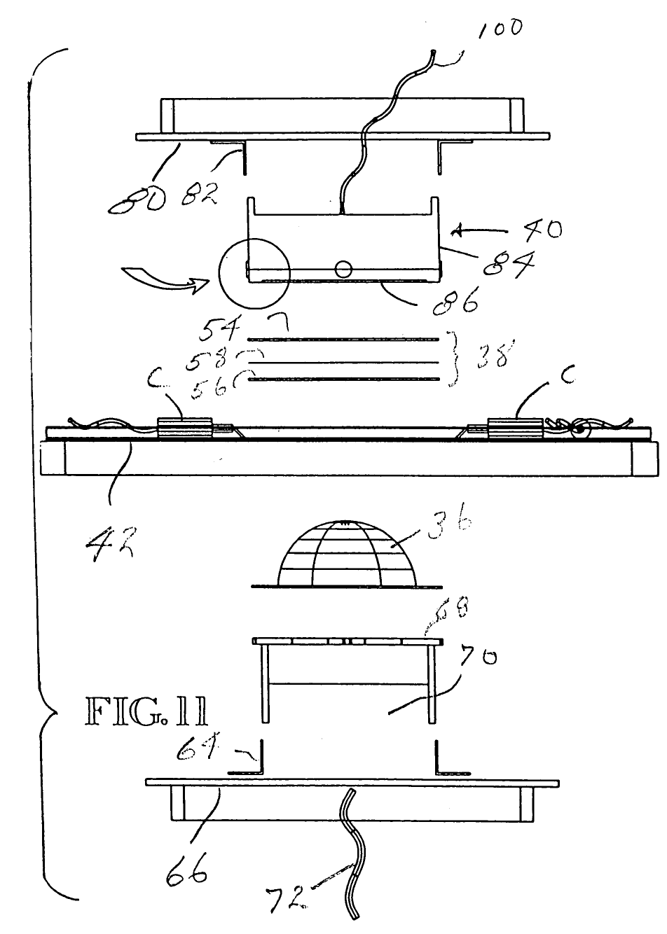

FIG. 10 is a sectional view showing the upper layer 54, the lower layer 56 and the decorative layer 58. The thickness dimension may vary substantially, e.g., from about 0.118-1.00 inches. Each layer 54, 56 may be made up of one or plural sheets. More than one decorative layer may be used.

According to an aspect of the invention, pressure may be used in addition to or in place of the vacuum to move the sandwich structure against the forming surface. Referring to FIG. 11, the upper housing 40 may include an upper frame 80 having angle iron 82 by which it is attached to an enclosure 84 having a high strength silicone diaphragm 86 or the like, secured to its lower end. A rectangular frame 88 has four sides and a top. The wall of the upper enclosure 40 includes a bottom edge 90 which rest down onto the top of the frame 88. A plurality of spacer lugs 92 are secured to the housing 34. The housing 34 is positioned generally above frame 88 and it is then moved downwardly, causing the lugs 92 to be positioned laterally outwardly of the outside wall of frame member 88, all the way around the frame member 88. The diaphragm 86 contacts the top of the sandwich of materials 38. It stretches in its middle so that it and the sandwich structure below it will be encouraged to move against the mold 36. A pressurized fluid, e.g., compressed air, is communicated via passageway 100 to the interior of the housing 40. This pressure presses against the layer 86 and then against the sandwich structure 38, moving structure 38 against the convex surface of the mold 36.

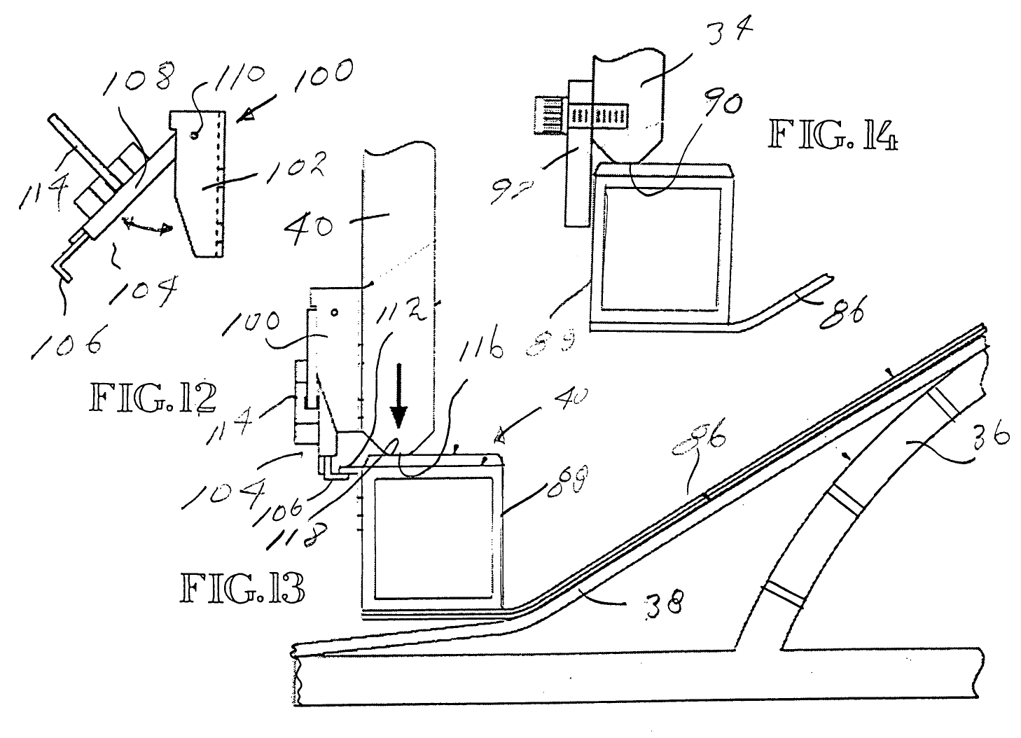

The circled portion of FIG. 11 is shown by FIG. 14. Frame 40 is provided with a plurality of clamps 100 spaced around its peripheral. These clamps are conventional per say. By way of typical and therefore non-limitive example, they may be a Southco clamp comprising a base 102 that is connected to the frame 40 (FIG. 13) and mounts a hook assembly 104. Hook assembly 104 includes a hook 106 that is movable up and down relative to a mounting member 108. The mounting member 108 is swingable above axis 110 towards and away from the mount 102. In use, the hook assembly is swung into the position shown by FIG. 13, placing the hook element 106 below a catch 112 that is a part of the frame 88. Then, a control lever 114 is operated to draw the hook element 104 upwardly into contact with the catch 112. When all of the clamps 100, spaced around the housing 40 are secured, the lower edge 116 of the housing sidewall is moved tight against the upper surface 118 of the frame 88 so that when pressure is applied it will not leak between the surfaces 116, 118.

The heated sandwich structure 38 is positioned above the male mold 36 and the assembly of frame 88, diaphragm 86 in housing 40 are lowered, causing the diaphragm 86 to be move against the sandwich structure 38. Pressure is then introduced then into the interior of the housing 40. This pressure acting on the diaphragm 86 will further move the heated sandwich structure 38 until it is tight against the forming surface of the male mold 36.

As an option, a texture, e.g., embossing, can be created on one or both sides of the sandwich structure 38. This is done by the use of silicone texture pads which are preembossed. The desired texture is transferred from a texture plate to the silicone pads. The textured or embossed silicone pads may be made as follows: a sheet of uncured silicone (0.108-0.118 inches thick) is placed on top of a Teflon coated film sheet that has been laid on top of a metal sheet plate. The texture sheet plates are set down on top of the uncured silicone sheet. Preferably, the textured plates are coated with Teflon or some other substance such as soap, to avoid sticking of the silicon to the plate. A metal sheet is then positioned on top of the textured plate to complete a sandwich structure which is referred to as a “book.” This “book” is put into autoclave oven and is heated between 200 to 300 degrees Fahrenheit, and the autoclave is operated at a pressure of between 60 psi to 120 psi. The “book” is held within the auto clave from between 60-80 minutes, depending on the texture. Then, the “book” is removed and the layers of the sandwich are separated. The cured silicone sheet which has been texturized or embossed by this process is then used to create a texture and emboss patterns on the basin formed by use of the equipments shown on FIGS. 9 and 11.

The following is an example of how to use the textured silicone pads to texture or emboss the surfaces of the basins 10. The textured silicone pad is mounted with its textured side out within a metal frame by use of mechanical fasteners or an adhesive so that the pad is airtight on the frame. The frame is then fastened to the rim of the pressure chamber 40 as has been described above. Firstly, the vacuum process may be used to pull the sandwich structure 38 against the forming surface of the male mold 36. Then, the pressure chamber and the silicone texture pad are lowered against the formed sandwich structure 38. Pressure is introduced into the housing 40, causing fluid pressure above the diaphragm 86 to push the sandwich structure 38 into the mold corners. This moves the texture silicone pad against the sandwich structure 38, causing it to emboss a complementary texture onto the molded sandwich structure 38. At the same time, the layers 54, 56,58 and the sandwich structure are caused to bond and form together an integral structure.

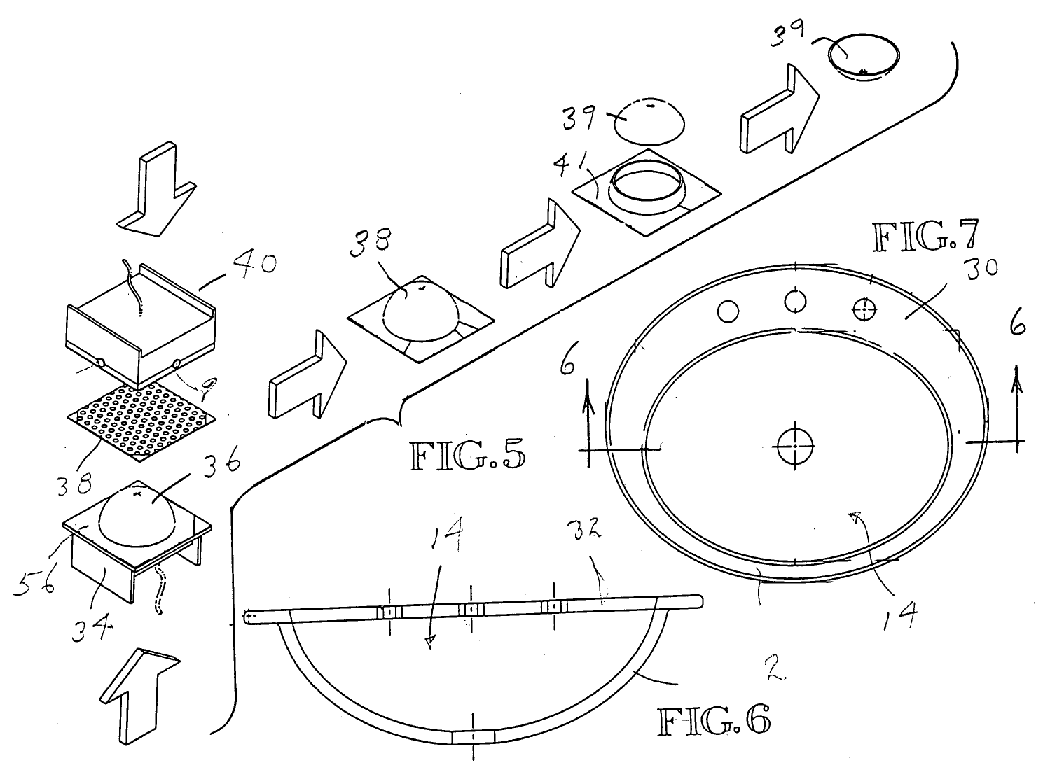

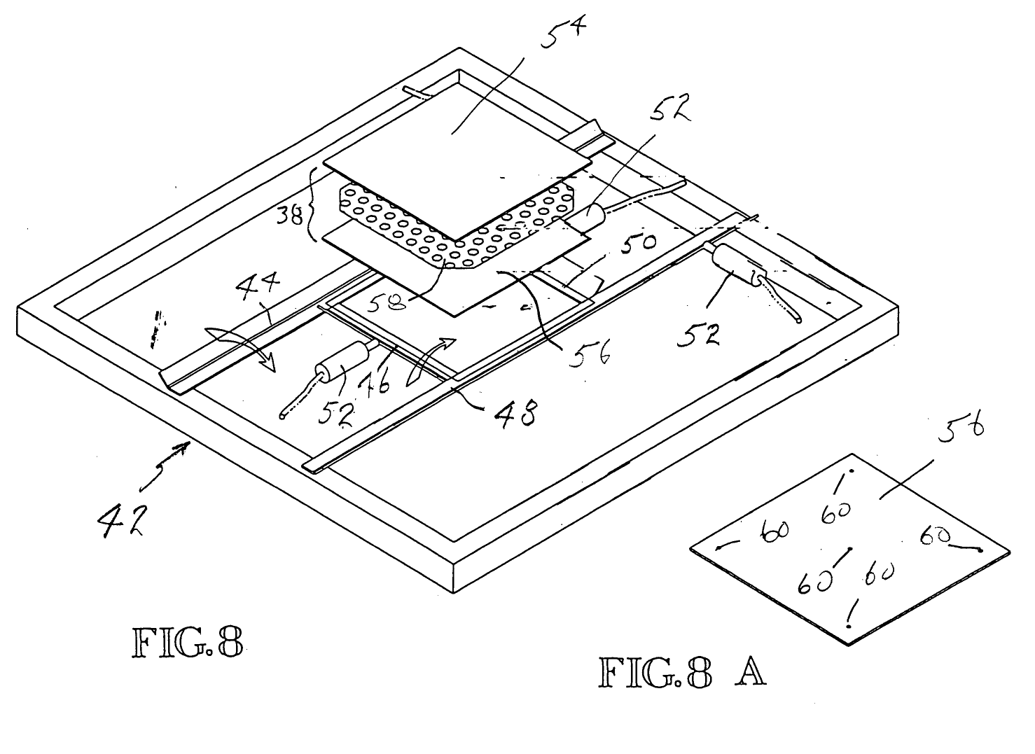

FIGS. 15 and 16 show a basin 130 that has four sides and a bottom. In the illustrated embodiment, the four sides 132, 134, 136, 138 converge from their tops to their bottoms. The bottom 140 is shown to be flat. Other embodiment of the invention can be created that have shapes somewhere between the rounded shapes shown by FIGS. 3 and 4 and the substantially straight walled shape shown by FIGS. 15 and 16. Although its sides and bottom are not curved, the basin 130 shown by FIGS. 15 and 16 has a convex-concave form.

The illustrated embodiments are only examples of the present invention and, therefore, are non-limitive. It is to be understood that many changes in the particular structure, materials and features of the invention may be made without departing from the spirit and scope of the invention. It is my intention that my patent rights not be limited by the particular embodiments illustrated and described herein, but rather are to be determined by the following claims, interpreted according to accepted doctrines of patent claim interpretation, including use of the doctrine of equivalents and reversal of parts.

What is claimed is:

1. A convex/concave object, comprising:
a co-polymer first layer;
a co-polymer second layer;
a decorative third layer sandwiched between the first and second layers; and
said first, second and third layers being bonded together to form an integrated structure.

2. The object of claim 1, wherein said first co-polymer layer is selected from the group of materials comprising polymethylmethacrylate, polycarbonate, polyvinyl chloride and polyethylene terephthalate glycol (PETG);
said second co-polymer layer is selected from the group of materials comprising polymethylmethacrylate, polycarbonate, polyvinyl chloride and polyethylene terephthalate glycol (PETG).

3. The object of claim 2, wherein the co-polymer first layer and the co-polymer second layer are both polymethylmethacrylate.

4. The object of claim 2, wherein the co-polymer first layer is polymethylmethacrylate and the co-polymer second layer is polycarbonate.

5. The object of claim 2, wherein the co-polymer first layer is polymethylmethacrylate and the co-polymer second layer is polyvinyl chloride.

6. The object of claim 2, wherein the co-polymer first and second layers are both polycarbonate.

7. The object of claim 2, wherein the co-polymer first layer is polycarbonate and the co-polymer second layer is polymethylmethacrylate.

8. The object of claim 2, wherein the co-polymer first layer is polycarbonate and the co-copolymer second layer is polyvinyl chloride.

9. The object of claim 2, wherein the co-polymer first and second layers are both polyvinyl chloride.

10. The object of claim 2, wherein the co-polymer first layer is polyvinyl chloride and the co-polymer second layer is polymethylmethacrylate.

11. The object of claim 2, wherein the co-polymer first layer is polyvinyl chloride and the co-polymer second layer is polycarbonate.

12. The object of claim 2, wherein at least one of the co-polymer first and second layers is continuous cast cross-link polymethylmethacrylate.

13. The object of claim 2, wherein at least one of the co-polymer first and second layers is extruded polymethylmethacrylate.

14. The object of claim 1, wherein at least one of the co-polymer layers is a co-polyester.

15. The object of claim 14, wherein the co-polyester is polyethylene terephthalate glycol (PETG).

16. The object of claims 1-15, wherein the decorative third layer is selected from the group of materials comprising textile fabrics, dry plant leafs, dried grasses, dried flowers, rocks, gems, glitter, crushed glass, metals, meshes, wire, wood veneers, twigs, shells, glass beads, ceramic beads, poly beads, papers, vinyls and combinations thereof.

17. The object of claims 1-15, wherein at least one exposed surface of the object is textured.

18. The object of claims 1-15, having a thickness within the range of about 0.11 inch to about 1.0 inch.

19. A method of making a convex/concave object, comprising:
providing a mold having a forming surface;
providing a sandwich of sheet materials comprising a co-polymer first layer, a co-polymer second layer and a decorative third layer between the first and second layers;
heating the sandwich of sheet materials to a plastic state;
moving the heated sandwich of sheet materials and the forming surface of the mold relatively together, with the forming surface of the mold contacting the heated sandwich of sheet materials;
pressing the heated sandwich of sheet materials against the forming surface of the mold, causing the sheet materials to bond together and conform to the shape of the forming surface of the male mold;
separating the formed sandwich of sheet materials from the mold; and
trimming the formed sandwich of sheet materials to provide a convex/concave object with a trimmed edge.

20. The method of claim 19, comprising applying a pressurized fluid against the sandwich of sheet materials for pressing them against the forming surface of the mold.

21. The method of claim 19, comprising providing the mold with openings and subjecting the side of the mold opposite the forming surface to a vacuum, and using the vacuum for moving the heated sandwich of sheet materials against the surface of the mold.

22. The method of claim 21, further comprising applying a positive fluid pressure against the heated sandwich of sheet materials for pressing it against the forming surface of the mold.

23. The method of claim 19, further comprising selecting the first co-polymer layer is selected from the group of materials comprising polymethylmethacrylate, polycarbonate, polyvinyl chloride and polyethylene terephthalate glycol (PETG). and selecting the second co-polymer layer from a group of materials comprising polymethylmethacrylate, polycarbonate, polyvinyl fluoride and polyethylene terephthalate glycol (PETG).

24. The method of claim 23, wherein the co-polymer first layer and the co-polymer second layer are both polymethylmethacrylate.

25. The method of claim 19, wherein the co-polymer first layer is polymethylmethacrylate and the co-polymer second layer is polycarbonate.

26. The method of claim 19, wherein the co-polymer first layer is polymethylmethacrylate and the co-polymer second layer is polyvinyl chloride.

27. The method of claim 19, wherein the co-polymer first and second layers are both polycarbonate.

28. The method of claim 19, wherein the co-polymer first layer is polycarbonate and the co-polymer second layer is polymethylmethacrylate.

29. The method of claim 19, wherein the co-polymer first layer is polycarbonate and the co-copolymer second layer is polyvinyl chloride.

30. The method of claim 19, wherein the co-polymer first and second layers are both polyvinyl chloride.

31. The method of claim 19, wherein the co-polymer first layer is polyvinyl chloride and the co-polymer second layer is polymethylmethacrylate.

32. The method of claim 19, wherein the co-polymer first layer is polyvinyl chloride and the co-polymer second layer is polycarbonate.

33. The method of claim 19, wherein at least one of the co-polymer first and second layers is continuous cast cross-link polymethylmethacrylate.

34. The method of claim 19, wherein at least one of the co-polymer first and second layers is extruded polymethylmethacrylate.

35. The method of claims 19-34, comprising selecting the decorative third layer from the group of materials comprising textile fabrics, dry plant leafs, dried grasses, dried flowers, rocks, gems, glitter, crushed glass, metals, meshes, wire, wood veneers, twigs, shells, glass beads, ceramic beads, poly beads, papers, vinyls and combinations thereof.

36. The method of claims 19-34, comprising providing texture at least one exposed surface of the object.

37. The method of claim 19, wherein at least one of the first and second co-polymer layers is a co-polyester.

38. The method of claim 37, wherein the co-polyester is polyethylene terephthalate glycol (PETG).

39. The method of claim 19, wherein the first and second co-polymer layer is polymethylmethacrylate.
